(19) United States
(12) Patent Application Publication
(10) Pub. No.: US 2025/0005672 A1
(43) Pub. Date: Jan. 2, 2025

(54) REVENUE BASED INVESTING

(71) Applicant: Marc R. DESCHENAUX, Geneva (CH)

(72) Inventor: Marc R. DESCHENAUX, Geneva (CH)

(21) Appl. No.: 18/760,431

(22) Filed: Jul. 1, 2024

Related U.S. Application Data
(60) Provisional application No. 63/524,364, filed on Jun. 30, 2023.

(51) Int. Cl. G06Q 40/06

(52) U.S. Cl. CPC G06Q 40/06

(57) ABSTRACT

A system and methods for managing securitization of revenue streams wherein investors are paid from the revenue stream associated with sale of goods or services as the revenues are received. The system and methods for managing securitization of revenue is conducted by a distributed networked computer system receiving and accepting bids from investors for revenue backed securities, tracking revenue and paying investors when triggering events are determined.

### CROSS REFERENCE TO RELATED APPLICATIONS

This application claims the benefit of U.S. Provisional Application Ser. No. 63/524,364 filed Jun. 30, 2023, the contents of which are incorporated herein in their entirety.

### FIELD OF THE INVENTION

The present disclosure relates to the field of assets and financing and specifically to the securitization of revenue streams. More specifically, systems and methods are disclosed which generally relate to executing transactions for securities based on revenue streams.

### BACKGROUND

In traditional financing, the relationship between a company and an investor takes one of two general forms: equity investment, where the investor takes a stake of ownership in the company in exchange for capital; or debt financing, where the investor lends money to the company to be repaid with interest over time.

A security has been defined as any instrument to which a right to an asset attaches in such a manner that it may not be exercised or transferred to another without the instrument, typically for the purpose of raising capital by selling it to other investors. The process of securitization relies upon agreement (contract), indenture, or specific legal regulation, establishing, for instance, stocks and shares. A pass-through security has its origins in mortgage-backed securities. A pass-through security is backed by one or more income generating assets. A servicing intermediary collects the monthly payments from the issuer(s) and, after deducting a fee, remits or passes them through to the holders of the pass-through security (that is, the investors).

A pass-through security is also known as a “pay-through security” or a “pass-through certificate”—though technically the certificate is the evidence of interest or participation in the income generating asset(s) that signifies the transfer of payments to investors; it is not the security itself.

A pass-through security is a derivative based on revenues that provides the investor a right to a portion of those incomes. Often, the revenues are from underlying asset(s), which can include things such as mortgages on homes or loans on vehicles. Each security can represent many revenue streams, such as hundreds of home mortgages or thousands of car loans. Extension of the concept of pass-through securities to the realm of entity financing may encourage greater investment in in new business development.

### SUMMARY

From the foregoing discussion, it should be apparent that a need exists for a system and method that enable financing of businesses. Beneficially, such a system and method would establish a reliable marketplace to increase incentives for investing in businesses, optimize patterns of productivity and fungibility of revenue streams. The innovation presented herein allows for the securitization of revenue streams.

Provided is a security for monetizing or securitizing revenue, wherein the security comprises a pass-through security that pays a portion of a revenue stream, such as a payment based on revenue earned by an entity, to the holder of the security as the revenue is received by the issuer of the security.

Provided is a revenue-based investment security (RBIS) comprising investment shares providing a defined payout to investors based on the revenue stream associated with a business entity and systems and methods for managing the RBIS. In an embodiment the RBIS comprises investment shares backed by a revenue stream based on an assigned good, service or asset providing a defined payout to an investor based on a portion of the revenue stream.

A first aspect provides a distributed networked computer system for managing securitization of revenue streams, the distributed network computer system comprising: a non-transitory computer readable storage medium having program instructions embodied therewith; and one or more processors configured to execute the program instructions to cause the computing system to receive, from a first networked node, a first bid for one or more shares of a revenue-based investment security (“RBIS”) from a first investor; determine, by a central processor, a fractional share of the RBIS to allocate to the first investor based on the first bid; allocate, by one or more processors, the fractional share of the RBIS to the first user; a distributed ledger for recording bids for the RBIS and respective allocated shares determined by the central processor, wherein the distributed ledger is accessible by the first networked node; and a smart contract accessible to the first networked node, wherein the smart contract comprises a revenue stream payout triggering event; and a plurality of predetermined electronic actions for generating a smart contract output when the revenue stream payout triggering event is met, wherein the smart contract generates a revenue stream payout to the first investor automatically when the payout event is triggered, and further wherein the execution of the smart contract is recorded to the distributed ledger.

Embodiments of the system include the following, alone or in any combination.

The smart contract is between the first investor and an issuer of the revenue-based investment security.

The payout triggering event is based on revenue associated with monetization of a business, such as revenue associated with sales of a good or service.

The system may further comprise one or more processors configured to execute the program instructions to cause the computing system to receive, from a plurality of networked nodes, a plurality of bids for one or more shares of a revenue-based investment security (“RBIS”) from a plurality of investors, determine, by the central processor, a fractional share of the RBIS to allocate to each of the plurality of investors based on the respective bids associated with each investor; and allocate, by one or more processors, the fractional shares of the RBIS to each of the plurality of investors. In the system, a plurality of smart contracts are accessible to the plurality of networked nodes, wherein each of the plurality of smart contracts comprises a revenue stream payout triggering event; and a plurality of predetermined electronic actions for generating a smart contract output when the revenue stream payout triggering event is met, wherein the smart contract generates a revenue stream payout to at least some of the plurality of investors automatically when the revenue stream payout event is triggered and further wherein each execution of each of the smart contracts is recorded to the distributed ledger.

The payout triggering event may comprise a threshold that occurs when income exceeds expenses associated with the business. The payout triggering event may comprise a periodic payout based on revenue associated with the business.

In some instances, only some of the smart contracts are executed to distribute a payout when a threshold triggering event is met, based on the terms of each smart contract.

A second aspect provides a non-transitory computer readable storage medium comprising a plurality of computer readable instructions embodied thereon wherein the instructions, when executed by a distributed networked computer system for managing securitization of revenue streams, cause the distributed networked computer system to receive, from a first networked node, a first bid for one or more shares of a revenue-based investment security (“RBIS”) from a first investor; determine, by a central processor, a fractional share of the RBIS to allocate to the first investor based on the first bid; allocate, by one or more processors, the fractional share of the RBIS to the first user; record in a distributed ledger accessible by the first networked node, bids for the RBIS; respective allocated shares determined by the central processor; and execution of a smart contract accessible to the first networked node, wherein the smart contract comprises a revenue stream payout triggering event; and a plurality of predetermined electronic actions for generating a smart contract output when the revenue stream payout triggering event is met, wherein the smart contract generates a revenue stream payout to the first investor by automatically when the payout event is triggered.

Embodiments of the non-transitory computer readable storage medium include the following, alone or in any combination.

The smart contract is between the first investor and an issuer of the revenue-based investment security.

The payout triggering event may be based on revenue associated with monetization of a business, such as revenue associated with sale of a good or service by an entity.

The instructions further cause the distributed networked computer system to receive, from a plurality of networked nodes, a plurality of bids for one or more shares of a revenue-based investment security (“RBIS”) from a plurality of investors, determine, by the central processor, a fractional share of the RBIS to allocate to each of the plurality of investors based on the respective bids associated with each investor; and allocate, by one or more processors, the fractional shares of the RBIS to each of the plurality of investors. The instructions may further cause the distributed networked computer system to record to the distributed ledger a plurality of smart contracts accessible to the plurality of networked nodes, wherein each of the plurality of smart contracts comprises a revenue stream payout triggering event; and a plurality of predetermined electronic actions for generating a smart contract output when the revenue stream payout triggering event is met, wherein the smart contract generates a revenue stream payout to at least some of the plurality of investors automatically when the revenue stream payout event is triggered and further wherein each execution of each of the smart contracts is recorded to the distributed ledger.

The payout triggering event may comprise a threshold that occurs when income exceeds expenses associated with a business. The payout triggering event may comprise a periodic payout based on revenue produced by the business.

In some instances, only some of the smart contracts are executed to distribute a payout when a threshold triggering event is met, based on the terms of each smart contract.

A third aspect is a method for managing securitization of revenue by a distributed networked computer system, the method comprising receiving, from a first networked node, a first bid for one or more shares of a revenue-based investment security (“RBIS”) from a first investor; determining, by a central processor, a fractional share of the RBIS to allocate to the first investor based on the first bid; allocating, by one or more processors, the fractional share of the RBIS to the first user; recording in a distributed ledger, wherein the distributed ledger is accessible by the first networked node, bids for the RBIS; respective allocated shares determined by the central processor; and execution of a smart contract accessible to the first networked node, wherein the smart contract comprises a revenue stream payout triggering event; and a plurality of predetermined electronic actions for generating a smart contract output when the revenue stream payout triggering event is met, wherein the smart contract generates a revenue stream payout to the first investor by automatically when the payout event is triggered.

Embodiments of the non-transitory computer readable storage medium include the following, alone or in any combination.

The method may further comprise the distributed networked computer system receiving, from a plurality of networked nodes, a plurality of bids for one or more shares of a revenue-based investment security (“RBIS”) from a plurality of investors, determining, by the central processor, a fractional share of the RBIS to allocate to each of the plurality of investors based on the respective bids associated with each investor; and allocating, by one or more processors, the fractional shares of the RBIS to each of the plurality of investors. The method may further comprise the distributed networked computer system recording to the distributed ledger a plurality of smart contracts accessible to the plurality of networked nodes, wherein each of the plurality of smart contracts comprises a revenue stream payout triggering event; and a plurality of predetermined electronic actions for generating a smart contract output when the revenue stream payout triggering event is met, wherein the smart contract generates a revenue stream payout to at least some of the plurality of investors automatically when the revenue stream payout event is triggered and further wherein each execution of each of the smart contracts is recorded to the distributed ledger.

The smart contract may be between the first investor and an issuer of the revenue-based investment security.

The payout may be based on revenue associated with monetization of the business such as income from sale of a good or service.

The payout triggering event may comprise a threshold that occurs when income exceeds expenses associated with a business. The payout triggering event may comprise a periodic payout based on revenue from the business.

In some instances, only some of the smart contracts are executed to distribute a payout when a threshold triggering event is met, based on the terms of each smart contract.

In some instances, only some of the smart contracts are executed to distribute a payout when a threshold triggering event is met, based on the terms of each smart contract.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered as limiting of its scope, the invention will be described and explained with additional specificity and detail using the accompanying drawings.

FIGS. 1A-1C depict schematic diagrams of models of financing businesses.

FIGS. 2A-2B depict a schematic functional diagram of a computer system relating to planning and developing securities, modeling and evaluating alternatives, as well as executing and administering an offering for sale of securities according to an exemplary embodiment of the disclosed subject matter.

FIG. 3 depicts a functional diagram of components of a computer system according to an exemplary embodiment of the disclosed subject matter.

FIG. 4 shows a process flow diagram for defining, offering for sale and administering a revenue-based investment security according to an embodiment of the disclosed subject matter.

FIGS. 5A and 5B are schematic diagrams illustrating example embodiments of a system comprising nodes and users that may be involved in a distributed networked system utilizing one or more smart contracts on a distributed ledger technology platform offering for sale and administering a revenue-based investment security in accordance with disclosed subject matter.

### DETAILED DESCRIPTION

In accordance with various embodiments of the invention, and as shown in the figures, various systems and methods are disclosed which generally provide a platform for the creation, communication, price quotation, and execution of trades for specified pools of revenue-based investment securities.

This disclosure provides systems and methods for securitization of revenue streams.

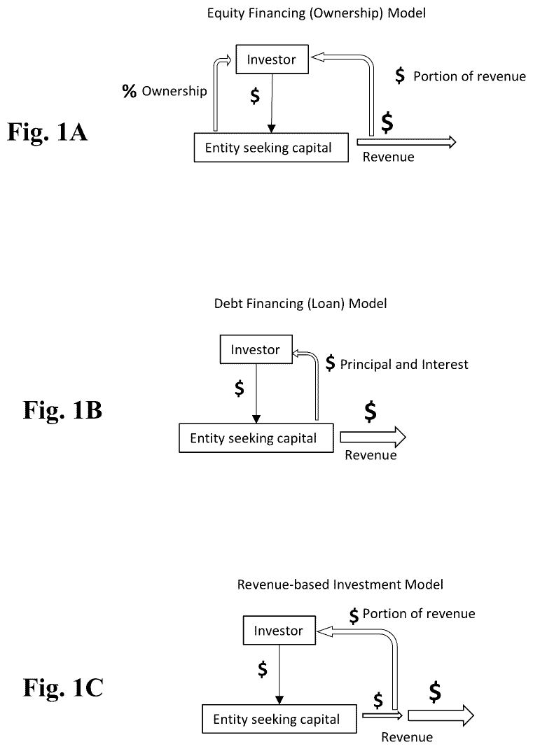

In traditional financing, the relationship between a company and an investor takes one of two general forms: equity investment, where the investor takes a stake of ownership in the company in exchange for capital; or debt financing, where the investor lends money to the company to be repaid with interest over time. FIGS. 1A and 1B show schematic diagrams of traditional models for financing businesses.

In an equity financing or ownership model shown in FIG. 1A, a business, company, or organization (collectively referred to as an ‘Entity’) seeking capital receives capital from an investor in exchange for the investor obtaining an ownership stake in the company. There is no immediate requirement to begin paying back the investor the amount of the capital received. However, the investor is entitled to a portion of the revenue earned by the Entity based on the investor's percentage of ownership in the company, which is ongoing as long as the investor has equity in the company. Advantages of this model are that the Entity does not have to pay back the investor if no revenue is generated, but disadvantages include the Entity ceding equity, including potential control, to the investor and reduced revenue to the original Entity because the investor has an ownership claim on a portion of the revenue.

In a debt financing or loan model shown in FIG. 1B, an entity seeking capital receives capital from an investor in the form of a loan. The loan includes a payment schedule for the entity to pay back the investor for the loan, including the amount of principal and interest to be paid according to the payment schedule. The interest is usually based on the interest prevailing in the market when the loan is initiated. Payments to the investor are not dependent on revenue generated by the business, and generally require immediate and continuous payments to the investor until the loan is paid off. The advantages of this model is that the Entity does not give up equity (ownership) in the company, but disadvantages include the obligation to pay off the loan during a time when revenues may be limited because the business is not sufficiently developed to generate revenue.

Revenue-Based Investing (RBI), Revenue-Sharing Financing (RSF), and Revenue Discount (RD) represent a new paradigm for financing businesses. The RBI, RSF, or RD model introduces an innovative alternative to the conventional equity or debt financing methods. FIG. 1C shows a schematic diagram of this new method for financing businesses.

In this new model, an investor provides capital to a business, company, or organization (collectively referred to as the ‘Entity’) in exchange for a percentage of the Entity's ongoing gross or net revenues. This is a fundamental shift away from traditional financing models. Unlike in debt financing, the Entity is not required to repay a fixed sum of money over a fixed period. The investor's return on investment is based on receiving a portion of future revenue until the inventor's principal and an agreed profit is paid off. After that, the Entity owes nothing to the investor and receives all future revenues associated with the business. Unlike in equity investment, the Entity does not cede any ownership stake to the investor.

The implications of this model are far-reaching and profoundly beneficial for both parties involved. Since the investor's return is directly tied to the Entity's performance, with earnings fluctuating in tandem with revenues, both parties' interests are inherently aligned. They both stand to benefit directly from the Entity's success and similarly bear the impact of any business downturn.

This dynamic fosters an environment of mutual support, collaboration, and shared ambition. It alleviates the pressure on the Entity to meet fixed debt repayments, a major source of stress for many businesses, particularly startups and smaller companies without substantial capital reserves. In parallel, it eliminates concerns over diluting ownership that often accompany equity investments, allowing the Entity to retain full control over its operations and strategic direction.

The term Revenue-based Investment Security relates to the transaction process of securitizing revenue from an entity and/or a business associated with the entity. It originates with the revenue received by the entity and may be associated with the business, which passes through a collecting society before being released to the investor.

Monetization is the action or process of earning revenue from an asset, such as a good or service offered for sale. A Revenue-based Investment Security may comprise a revenue stream derived from monetization of goods or services. A servicing intermediary may collect revenue payments from the issuer and, after deducting a small management fee, remits or passes a portion of the revenue through to the holders of the revenue-based pass-through security.

For example, an Entity may define a good or product for sale, which can be tracked through manufacture through sale to a customer for determining revenue associated with the good. In another example, a service offered by an entity, where payments to the entity for performing the service may be assigned to the RBIS. The issuer determines a valuation for the assigned good or service and defines an offering of revenue-based investment securities based on the assigned good or service for sale to one or more investors. The offering defines a plurality of fractional shares of the RBIS that provide a future payout to the investors based on revenue derived by the entity. Investors purchase fractional shares of the RBIS based on promise of future earnings.

Legitimizing the RBI, RSF, or RD model includes establishing legal instruments and considerations. To legally enforce the RBI, RSF, or RD model, it is important to codify the agreement between the investor and the Entity. The Revenue-Based Investing Agreement (RBIA), Revenue-Sharing Financing Agreement (RSFA), or Revenue Discount Agreement (RDA) serves this purpose. Under certain Roman law jurisdictions, this agreement may be published as an annotation to the register of commerce.

The agreement spells out the specifics of the financial relationship between the investor and the Entity, including the amount of investment, the percentage of revenues to be shared, and the duration of the agreement. Importantly, the agreement stipulates that the investment will last until the investor has received full repayment of the investment sum, plus an agreed profit. As the investor has a genuine risk of loss if the Entity's revenues fail to meet expectations, the RBIA, RSFA, or RDA is not subject to the usury limitations applicable to loan agreements. This is an essential distinction, as it safeguards the legality of the financial model and ensures its viability for the investor.

In embodiments, if the Entity is an established company with ongoing revenue streams from existing business(es), the ongoing revenue stream may serve as “collateral,” wherein the investor is paid from the ongoing revenue stream and the investment is used to finance a new business for the Entity.

In other embodiments, the Entity may be a small business or start-up company, and the revenue stream to pay the investor is a future revenue stream from sale of a good or service funded, at least in part, by the RBIS.

In embodiments, the payment schedule or amortization may be structured to pay the investor a fixed or variable percentage of the revenue stream plus a payment reflecting a portion of the agreed-upon profit. In embodiments, the payment schedule is structured under reverse amortization principles. The purpose of reverse amortization is to provide the Entity with low early (or no) payments, which allows them to establish the business and more easily afford payments to the investor under the RBIS when revenues grow as the business develops. As the term of the RBIS progresses, the Entity is probably expecting to increase income to offset rising payments to the investor. For example, the initial payments may be low for new businesses as these companies do not generally have sufficient cash flow for large payments. Initial payments may be predominantly based on the revenue generated while the profit component is low. After a period, larger payments come up, with a large percentage of this payment going toward investor profit, which makes up for the low payments in the early years of the financing.

A useful aspect of the RBI, RSF, or RD model is its potential for driving sustainability. By freeing the Entity from the burdens of debt repayment and concerns over ownership dilution, the model allows the Entity to focus on its core operations and strategic growth initiatives. This becomes particularly potent when applied to Entities engaged in sustainable practices or the green economy.

Entities can direct the investment towards initiatives that enhance their environmental performance, innovate sustainable products or services, or improve their social responsibility. These initiatives not only drive the Entity's growth but also contribute significantly to environmental conservation, social welfare, and the broader goals of sustainable development.

When aligned with green finance principles, this model could prove instrumental in accelerating the global transition to a sustainable economy. The investor, by supporting such Entities, becomes a direct contributor to this vital global objective. Therefore, the model serves to enhance the investor's corporate social responsibility profile and societal impact, in addition to offering a viable financial return.

The flexibility and adaptability of the RBI, RSF, or RD model further enhances its appeal. It can be tailored to suit a variety of industries, business models, and company sizes, making it a versatile tool in the arsenal of modern finance. For example, a technology startup might seek an investment to fund product development and market expansion. An agriculture enterprise might require capital to innovate sustainable farming techniques and organic products. A renewable energy company might need funding to scale its operations and invest in cutting-edge clean technologies. A company may finance a change in a manufacturing process to become more sustainable and associate a reduction in cost of goods sold (COGS) realized by the sustainable improvement as “revenue” backing a revenue-based investment security. RBI, RSF, or RD model can be applied effectively in each of these scenarios, and countless more.

While the model inherently involves a degree of risk for the investor, due to its revenue-dependent return structure, this risk is mitigated through several factors. First, the alignment of interests between the investor and the Entity ensures a collective effort towards business success, reducing the risk of underperformance or failure. Second, the agreement's duration—lasting until full repayment of the investment plus an agreed profit—is assured, offers the investor a measure of security and a clear financial prospect. Third, the legal enforceability of the RBIA, RSFA or RDA, provides a layer of protection for investors, allowing them recourse in the event of non-compliance.

The RBIS may be administered in a distributed networked computer system using smart contracts among the issuer, the Entity, and the investors. The system automatically pays out to investors in response to revenue stream triggering events based on the terms of the smart contracts. In embodiments, the issuer may hold a fraction of the RBIS to also receive future income from the revenue generated by the asset.

Each security can represent a single product (good or service) or a plurality of products offered by the Entity.

Payments may be made to investors periodically or following a triggering event, corresponding with the payment schedules set in the terms of the RBIS. For example, payments may be made quarterly based on quarterly reports of the revenue stream assigned to the RBIS. Triggering events may include certain milestones achieved during development of the business.

The revenue-based investment securities systems and methods described herein allow for investment in an entity, wherein individual investors can invest in specific business(es) and receive payments based on revenue associated with the business.

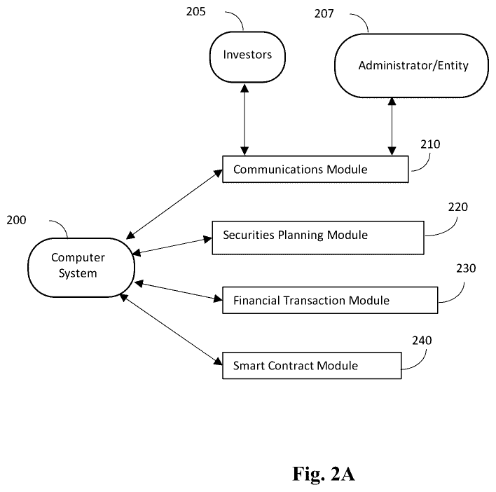

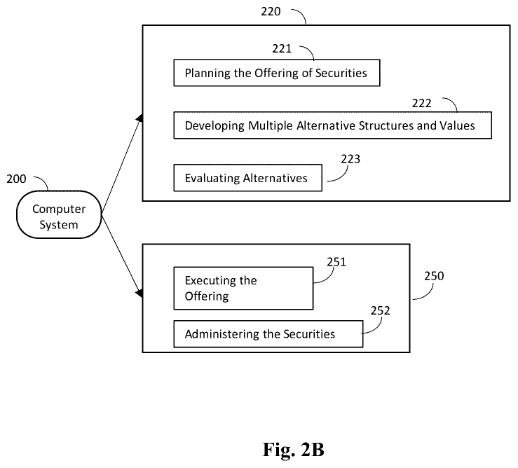

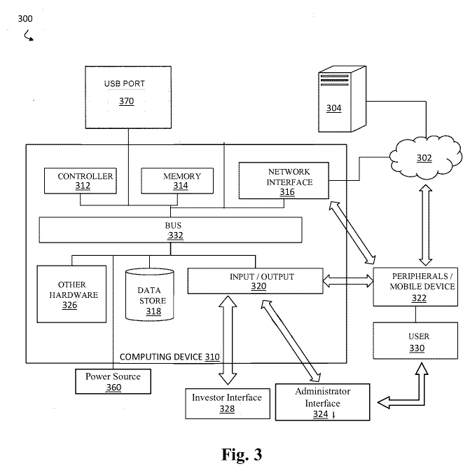

As shown in FIG. 2A, a computer system 200 is a core element of the photovoltaic revenue-based securities architecture, receiving, generating, storing, integrating and coordinating data required for defining a RBIS, receiving investment payments from a plurality of investors 205, matching bids from the plurality of investors, optionally generating smart contracts among investors and the company or issuer, determining revenues related to an assigned good, service or asset and administering payouts to investors. The computer system is further provided with at least one processor into which is loaded software components for receiving informational inputs from the plurality of investors via communications module or interface 210.

Block 210 represents a communication module, which manages inputs from investors and transmits outputs to the investors. Inputs from investors include investing information, investor identity, designation of a payment vehicle or digital “wallet”, such as a credit or debit account, including credit or debit cards issued by a financial institution, Venmo® or Pay Pal® apps, etc. Communications module 210 may also be used by administrator(s) 207 of the computer system to communicate with the system. Administrator(s) may provide inputs to the system to maintain and manage the system to make sure it is operating correctly. In embodiments, the administrator(s) 207 may also provide inputs to the system to designate revenue from sale of goods or services for investors to invest in, risks assessments, projected revenue streams, etc.

In block 220, the system includes a securities planning module in which the revenue-based securities are defined, as described in greater detail regarding FIG. 2B.

Block 230 comprises the financial transactions module that manages payments from investors to cover their bids, payments to investors and collection of transaction fees. In embodiments, once a bid is accepted, the financial transactions module may withdraw the bid amounts plus transaction fees from investors' payment vehicles in response to acceptance of bids by the computer system. Block 230 also receives payments from the revenue streams associated with the business backing the revenue-based securities and disburses payments to the investors based on the terms of the revenue-based securities.

In embodiments, the revenue-based securities may be offered in the form of a smart contract, described in greater detail below. In block 240, the smart contract module executes smart contracts by generating data blocks defining the revenue-based securities, including all terms and conditions binding on the investors and the Entity such as purchase prices, revenue streams from the revenue-based systems, percentages of the revenue streams represented by the securities, etc.

Block 250 shows the securities administration module, which executes and administers the revenue-based securities.

As shown in FIG. 2B, block 220 comprises aspects of defining the revenue-based security offerings.

In block 221, planning the offering of securities includes establishing the target amount of capital to be raised. Guided by inputs from administrator(s) of the system representing the seller, bank, broker, underwriter and/or other financial institutions, the system conducts feasibility studies for offering intellectual properties to define the structure of the offering. The offering planning includes specific variables to be included, ranges of acceptable values for each variable, and terms and conditions to be included in the offering.

In certain embodiments the status, quality and profitability of the business are analyzed according to market value. A process for risk calculation may be included in the process for valuation. The issued security may become the basis for a subscription, which is then available to an investor.

One can appreciate each business is unique, depending on the good or service offered for sale, the cost of production, the income expected to be generated, the value (price) of the good or service, etc.

In block 222, the system models and projects multiple values of individual variables and combinations of multiple sets of variables, such as time series projections and economic modeling of interaction among variables.

In block 223, the system evaluates alternatives by reviewing results of modeling and projections. Selecting one or more sets of variables that meet targets may be used to refine the structure and value of variables and terms and conditions for price categories of the revenue-based shares. Additional modeling and projections may be required to define a preferred set of values for the variables and terms and conditions for inclusion in the offering of securities in the price categories of the investment shares. When initiated by the seller, one or more revenue-based investment securities may be offered as individual or pooled assets. When initiated by a buyer, the buyer may input a desired type of security and the system may generate securities based on the defined characteristics.

FIG. 2B also shows block 250 comprising aspects of administering the revenue-based security offerings.

In block 251, the system executes the offering of the securities. The price and content of the individual shares of the price category tranches are established, including definitions of shares of revenues and assets to be included in each offering. Technical and legal details are finalized and the revenue-based investment securities are brought to market. The system receives and accepts bids for shares in each security from at least one investor, tracks progress of sales of shares within each security and closes sales when target values are met. The system may also receive sell orders from holders of shares and sell them to new investors.

Block 251 may comprise an order creation module. In general, the order creation module may have two modes of functionality. In a first mode, the order creation module permits a buyer to search a database of specified pools and to select one or more pools from the inventory for pricing by a selected group of sellers. It will be understood from the following disclosure that, although multiple pools are selected, any number of pools less than the total number selected (or none) may be quoted and ultimately traded. In a second mode, a buyer is provided with the option to select the characteristics of a desired specified pool. These characteristics may be transmitted through system 200 to one or more sellers. The sellers can identify one or more pools in their respective inventories that substantially meet the buyer's specified set of characteristics or agree to create a specified pool meeting such characteristics.

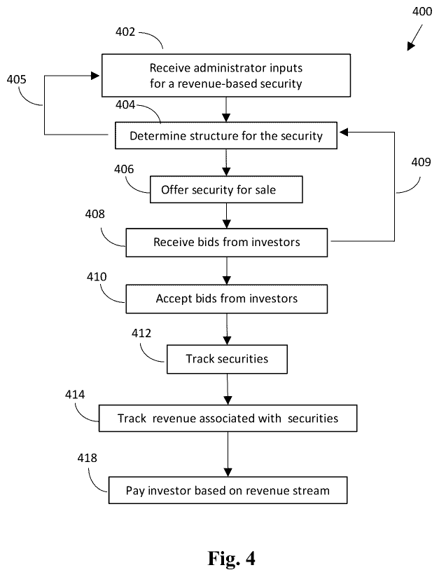

In operation, by setting various criteria and through selection of one or more sellers, through the operation of the order creation module, buyers can create a customized inventory query which will return available asset securities from database(s) in the system (See FIG. 3). In the alternative, the query can be submitted directly to the seller to determine whether the seller has or can stipulate to an asset security meeting the buyer's requirement. This feature may be used when a security meeting the buyer's requirement is not in the inventory of one or more sellers.

In an alternative embodiment, wherein one or more desired securities are not in an inventory of offered properties, a buyer (investor) may be enabled to send an inquiry message to one or more sellers inquiring as to the availability of a security meeting the buyer's needs. In this embodiment, a buyer typically creates an order query using system 200's order creation module to determine whether the desired security is listed in the system's database of securities previously populated by one or more sellers. Such query details may include, title(s) or other identifier(s) of assets, a pool number of an asset pool, a weighted average maturity, a constant payment rate, an originator identifier, etc. While the buyer may use various inventory filters to enable the buyer to search for securities meeting defined criteria, in some instances, the desired security may not be available. In those instances, the buyer can define the criteria according to which an inquiry message will be generated and transmitted to one or more sellers. A dealer or agent list may include a list of dealers, acting as sellers, and aspects of the buyer interface enable the buyer to select the dealers to which the inquiry message will be transmitted. Once the buyer completes the process of inputting desired criteria and selecting dealers, the criteria and dealer data is transmitted to and received by system 200. System 200 then generates an inquiry message which includes the characteristics for the pool of assets defined by the buyer. The data in the inquiry message is then transmitted to the selected dealer(s)

In block 252, the system administers the securities (shares) in the offering. The Entity and/or the issuer may engage manager and a collection society may collect and disperse payments. In an RBIS, the Entity is responsible to assign the revenue associated with the asset, good or service to the security for payout to the investor until defined thresholds are met. The revenue may be paid by the Entity in fixed or variable amounts depending on the terms of the security. The system maintains detailed and current records of individual investor and entity accounts as required for periodic and cumulative payments, tax treatment, benefits, reports and other purposes. It maintains required and useful records related to financial analysis and financial reports of investors, brokers, and other involved parties. In embodiments, the records may be recorded in a distributed ledger such as a blockchain.

In embodiments, the offering, sale, and administration of the revenue-based securities may be conducted as a smart contract. The smart contract embodies the Revenue-Based Investing Agreement (RBIA), Revenue-Sharing Financing Agreement (RSFA), or Revenue Discount Agreement (RDA) defining the relationship between the Entity and the investor and the terms of payments from the Entity to the investor based on the assigned revenue stream.

A smart contract is a computer application simulating the operation of a contract. It is a computer program or a transaction protocol which is intended to automatically execute, control or document legally relevant events and actions according to the terms of a contract or an agreement between or among parties. The objectives of smart contracts are the reduction of need in trusted intermediators, arbitrations and enforcement costs, fraud losses, as well as the reduction of malicious and accidental exceptions. The smart contract is stored on a distributed ledger such as a blockchain that runs when predetermined conditions are met. Distributed ledger technology (DLT) is a digital system for recording the transaction of assets in which the transactions and their details are recorded in multiple places at the same time. Unlike traditional databases, distributed ledgers have no central data store or administration functionality. They may be used to automate the execution of an agreement so that all participants can be immediately certain of the outcome, without any intermediary's involvement or time loss.

The reliability of the smart contract comes from its automaticity which gives it a power of execution unmatched to date.

A smart contract also can be regarded as a secured stored procedure as its execution and codified effects like the transfer of some value between parties are strictly enforced and cannot be manipulated, after a transaction with specific contract details is stored into a blockchain or distributed ledger. That is because the actual execution of contracts is controlled and audited by the platform, not by any arbitrary server-side programs connecting to the platform. Smart contracts are particularly useful for managing exchanges of virtual financial or value assets, where no tangible materials need to be moved.

Blockchain is a distributed ledger technology that enables a set of peers to work together to create a unified, decentralized network. The peers can communicate and share information or data with the help of a consensus algorithm. There is no need for a centralized authority, which makes the whole network trustworthy when compared to other networks. When one peer sends information to another, a transaction is generated in the form of a “block”. Blocks are used to store transactions and other important information that is required to operate the blockchain successfully. When this happens, the transactions need to be validated using the consensus algorithm. Proof of Work is used to validate the work. It ensures that no invalid transactions are passed into the blockchain. Timestamps are created to ensure that each transaction can be traced, backed, and verified by anyone. The blockchain provides transparency, immutability, and security.

The contracting parties program the contractual terms, payments to be made and all dispatches of documents used for the execution of the contract in the software application and may no longer retract their commitments. Once launched, the application performs the scheduled operations without human intervention, as scheduled or triggered by a defined triggering event.

End clients interact with a smart contract through transactions. Such transactions with a smart contract can invoke other smart contracts. These transactions might result in changing the state and sending financial assets from one smart contract to another or from one account to another. Financial assets can include nationally denominated currencies, cryptocurrencies, virtual stock certificates, or other asset whose value can be defined digitally.

Like a transfer of value on a blockchain, deployment of a smart contract on a blockchain occurs by sending a transaction from a wallet for the blockchain. The transaction includes the compiled code for the smart contract as well as a special receiver address. That transaction must then be included in a block that is added to the blockchain, at which point the smart contract's code will execute to establish the initial state of the smart contract. Byzantine fault-tolerant algorithms secure the smart contract in a decentralized way from attempts to tamper with it. Once a smart contract is deployed, it cannot be updated. Smart contracts on a blockchain can store arbitrary state and execute arbitrary computations.

The reliability of the smart contract can be greatly increased by relying on a decentralized IT environment allowing secure access to the contractors and unfalsifiable by them.

Each smart contract may include information about the investment in the revenue-based investment security. Such information may include the amount of the investment, the agreed upon payouts, triggering events, the revenue stream, the time the investment is agreed upon, the identities of the parties, etc. Investment information may further include conditional outcomes based upon each potential outcome, including the facilitation of payment from the seller to the investor, and/or the return of funds in event of a void or cancellation. In some embodiments, a settlement service may be agreed upon among the parties.

Some embodiments provide that the smart contracts may be generated on individual PC's, on a mobile device and/or in the cloud. Such examples are non-limiting as the smart contracts may be generated at a variety of other devices and/or types thereof. In some embodiments, each smart contract may involve external services at the discretion of the parties. In some embodiments, a range of options may be selected by the parties at the time the smart contract is generated.

Some embodiments provide that a smart contract may be registered with a settlement service provider that is agreed to by the parties. In some embodiments, a settlement service may provide information about the outcome, such as revenue generated, of the intellectual properties on which the security is based. In some embodiments, the settlement service may send the information to the counterparties, which may trigger the payouts under the terms of the smart contract. For example, the settlement service provider may initiate a bank transfer from the Entity to the investor based on the smart contract. In some embodiments, the process may be automated by software on a computer and/or server controlled by the settlement service. Embodiments herein do not require the funds to be held in any kind of escrow, however, such option is contemplated by this disclosure. For example, embodiments herein are directed to any financial settlement process that may be used in conjunction with the smart contracts as disclosed herein.

Some embodiments provide that the settlement transaction may be stored in blockchain to close the contract. In some embodiments, details corresponding to the settlement transaction may be retained for auditing, later scrutiny and/or to ensure that no errors are made.

FIG. 3 depicts a computer system 300 according to an embodiment of the present disclosure. In general, the computer system 300 may include a computing device 310, such as a special-purpose computer designed and implemented for receiving user inputs, determining and directing and controlling the output of signals. The computing device 310 may be or include data sources, client devices, and so forth. In certain aspects, the computing device 310 may be implemented using hardware or a combination of software and hardware. The computing device 310 may be a standalone device, a device integrated into another entity or device, a platform distributed across multiple entities, or a virtualized device executing in a virtualization environment.

The computing device 310 may communicate across a network 302. The network 302 may include any data network(s) or internetwork(s) suitable for communicating data and control information among participants in the computer system 300. This may include public networks such as the Internet, private networks, and telecommunications networks such as the Public Switched Telephone Network or cellular networks using cellular technology and/or other technologies, as well as any of a variety other local area networks or enterprise networks, along with any switches, routers, hubs, gateways, and the like that might be used to carry data among participants in the computer system 300. The network 302 may also include a combination of data networks and need not be limited to a strictly public or private network.

The computing device 310 may communicate with an external device 304. The external device 304 may be any computer, mobile device such as a cell phone, tablet, smart watch or other remote resource that connects to the computing device 310 through the network 302. This may include any of the servers or data sources described herein, including servers, content providers, databases or other sources for information to be used by the devices as described herein.

In general, the computing device 310 may include at least one controller or processor 312, a memory 314, a network interface 316, a data store 318, and one or more input/output interfaces 320. The computing device 310 may further include or be in communication with peripherals 322 and other external input/output devices that might connect to the input/output interfaces 320.

The controller 312 may be implemented in software, hardware or a combination of software and hardware. According to one aspect, the controller 312 may be implemented in application software running on a computer platform. Alternatively, the controller 312 may include a processor or other processing circuitry capable of processing instructions for execution within the computing device 310 or computer system 300. The controller 312, as hardware, may include a single-threaded processor, a multi-threaded processor, a multi-core processor and so forth. The controller 312 may be capable of processing instructions stored in the memory 314 or the data store 318.

The memory 314 may store information within the computing device 310. The memory 314 may include any volatile or non-volatile memory or other computer-readable medium, including without limitation a Random-Access Memory (RAM), a flash memory, a Read Only Memory (ROM), a Programmable Read-only Memory (PROM), an Erasable PROM (EPROM), registers, and so forth. The memory 314 may store program instructions, program data, executables, and other software and data useful for controlling operation of the computing device 310 and configuring the computing device 310 to perform functions for a user 330. The memory 314 may include a number of different stages and types of memory for different aspects of operation of the computing device 310. For example, a processor may include on-board memory and/or cache for faster access to certain data or instructions, and a separate, main memory or the like may be included to expand memory capacity as desired. All such memory types may be a part of the memory 314 as contemplated herein.

The memory 314 may, in general, include a non-volatile computer readable medium containing computer code that, when executed by the computing device 310 creates an execution environment for a computer program in question, e.g., code that constitutes processor firmware, a protocol stack, a database management system, an operating system, or a combination of the foregoing, and that performs some or all of the steps set forth in the various flow charts and other algorithmic descriptions set forth herein. While a single memory 314 is depicted, it will be understood that any number of memories may be usefully incorporated into the computing device 310.

The network interface 316 may include any hardware and/or software for connecting the computing device 310 in a communicating relationship with other resources through the network 302. This may include remote resources accessible through the Internet, as well as local resources available using short range communications protocols using, e.g., physical connections (e.g., Ethernet), radio frequency communications (e.g., Wi-Fi, Bluetooth), optical communications (e.g., fiber optics, infrared, or the like), ultrasonic communications, or any combination of these or other media that might be used to carry data between the computing device 310 and other devices. The network interface 316 may, for example, include a router, a modem, a network card, an infrared transceiver, a radio frequency (RF) transceiver for receiving AM/FM or satellite radio sources, a near field communications interface, a radio-frequency identification (RFID) tag reader, or any other data reading or writing resource or the like.

The network interface 316 may include any combination of hardware and software suitable for coupling the components of the computing device 310 to other computing or communications resources. By way of example and not limitation, this may include electronics for a wired or wireless Ethernet connection operating according to the IEEE 802.11 standard (or any variation thereof), or any other short or long range wireless networking components or the like. This may include hardware for short range data communications such as Bluetooth or an infrared transceiver, which may be used to couple to other local devices, or to connect to a local area network or the like that is in turn coupled to a data network 302 such as the Internet. This may also include hardware/software for a WiMax connection or a cellular network connection (using, e.g., CDMA, GSM, LTE, or any other suitable protocol or combination of protocols). The network interface 316 may be included as part of the input/output devices 320 or vice-versa.

The data store 318 may be any internal or external memory store providing a computer-readable medium such as a disk drive, an optical drive, a magnetic drive, a flash drive, or other device capable of providing mass storage for the computing device 310. The data store 318 may store computer readable instructions, data structures, program modules, and other data for the computing device 310 or computer system 300 in a non-volatile form for relatively long-term, persistent storage and subsequent retrieval and use. For example, the data store 318 may store an operating system, application programs, program data, databases, files, and other program modules or other software objects and the like. At least a portion of the data store 318 may be implemented in a distributed ledger technology such as a blockchain to record transaction information and smart contracts.

As used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

The input/output interface 320 may support input from and output to other devices that might couple to the computing device 310. This may, for example, include serial ports (e.g. RS-232 ports), universal serial bus (USB) ports, optical ports, Ethernet ports, telephone ports, audio jacks, component audio/video inputs, HDMI ports, and so forth, any of which might be used to form wired connections to other local devices. This may also include an infrared interface, RF interface, magnetic card reader, or other input/output system for wirelessly coupling in a communicating relationship with other local devices. It will be understood that, while the network interface 316 for network communications is described separately from the input/output interface 320 for local device communications, these two interfaces may be the same, or may share functionality, such as where a USB port 370 is used to attach to a Wi-Fi accessory, or where an Ethernet connection is used to couple to a local network attached storage. The input/output interface 320 may further output signals to displays of peripheral devices, as described herein.

As used herein, a user 330 is any human that interacts with the computer system 300. In this context, a user may be generally classed within one of two categories. One category is an administrator of the system, representing the entity and/or financial institution (issuer) organizing and conducting the offering of the revenue-based security. Another category is an investor who buys and sells shares in the revenue-based security.

In certain embodiments the I/O interface 320 facilitates communication with input and output devices for interacting with a user. For example, the I/O interface may communicate with one or more devices such as a user-input device and/or a display 350 which may be instantiated on the device described herein or on a separate device such as a mobile device 208, which enable a user to interact directly with the controller 312 via bus 332. The user-input device may comprise one or more push-buttons, a touch screen, or other devices that allows a user to input information. In these embodiments, the computer system may further comprise a display to provide visual output to the user. The display may comprise any of a variety of visual displays, such as a viewable screen, a set of viewable symbols or numbers, and so on. One can appreciate that the inputs and outputs of the computer system would be different for administrators and investors. Accordingly, the computing device 310 may communicate administrators and investors with different interfaces 324 and 328.

A peripheral 322 may include any device used to provide information to or receive information from the computing device 310. This may include human input/output (I/O) devices such as a keyboard, a mouse, a mouse pad, a track ball, a joystick, a microphone, a foot pedal, a camera, a touch screen, a scanner, or other device that might be employed by the user 330 to provide input to the computing device 310. This may also or instead include a display, a printer, a projector, a headset or any other audiovisual device for presenting information to a user. The peripheral 322 may also or instead include a digital signal processing device, an actuator, or other device to support control of or communication with other devices or components. In one aspect, the peripheral 322 may serve as the network interface 1316, such as with a USB device configured to provide communications via short range (e.g., Bluetooth, Wi-Fi, Infrared, RF, or the like) or long range (e.g., cellular data or WiMax) communications protocols. In another aspect, the peripheral 322 may augment operation of the computing device 310 with additional functions or features, or other device. In another aspect, the peripheral 322 may include a storage device such as a flash card, USB drive, or other solid-state device, or an optical drive, a magnetic drive, a disk drive, or other device or combination of devices suitable for bulk storage. More generally, any device or combination of devices suitable for use with the computing device 310 may be used as a peripheral 322 as contemplated herein.

Other hardware 326 may be incorporated into the computing device 310 such as a co-processor, a digital signal processing system, a math co-processor, a graphics engine, a video driver, a camera, a microphone, additional speakers, and so forth. The other hardware 326 may also or instead include expanded input/output ports, extra memory, additional drives, and so forth.

A bus 332 or combination of busses may serve as an electromechanical backbone for interconnecting components of the computing device 310 such as the controller 312, memory 314, network interface 316, other hardware 326, data store 318, and input/output interface. As shown in the figure, each of the components of the computing device 310 may be interconnected using a system bus 332 in a communicating relationship for sharing controls, commands, data, power, and so forth.

The computing device 310 is connected to a power source 360 to provide electrical power for the computing device to run.

The various illustrative logical blocks, modules and circuits described in connection with the present disclosure may be implemented or performed with one or more processors specially configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. Alternatively, the processing system may comprise one or more neuromorphic processors for implementing the neuron models and models of neural systems described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein. In the distributed networked system described herein, a plurality of processors on a plurality of devices provide a plurality of nodes for the network.

The steps of a method or algorithm described in connection with the present disclosure may be embodied directly in hardware, in a software module executed by a processor, or in a combination of the two. A software module may reside in storage or machine readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as with cache and/or specialized register files. Although the various components discussed may be described as having a specific location, such as a local component, they may also be configured in various ways, such as certain components being configured as part of a distributed computing system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of computer applications for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

The computer program controls input and operation of the device. The computer program includes at least one code segment stored in or on a computer-readable medium residing on or accessible by the device for instructing the computing elements, and any other related components to operate in the manner described herein. The computer program is preferably stored within the memory and comprises an ordered listing of executable instructions for implementing logical functions in the device. However, the computer program may comprise programs and methods for implementing functions in the device that are not an ordered listing, such as hard-wired electronic components, programmable logic such as field-programmable gate arrays (FPGAs), application specific integrated circuits, or other similar or conventional methods for controlling the operation of electrical or other computing devices.

Similarly, the computer program may be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. The computer-readable medium may even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

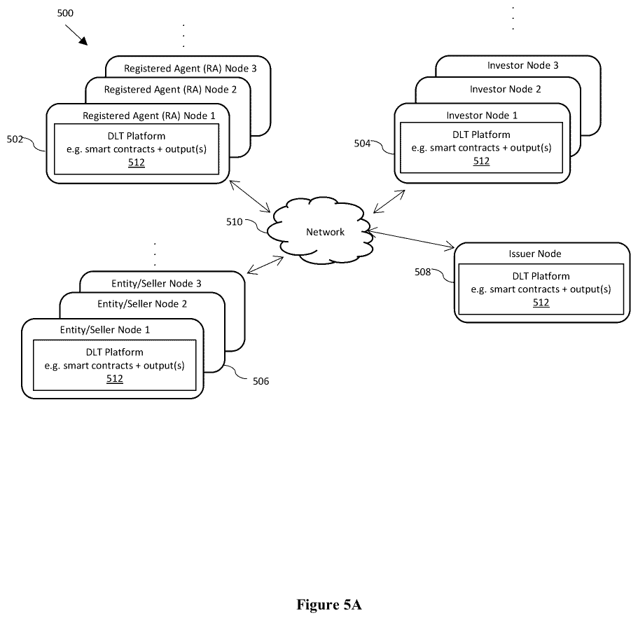

FIG. 4 shows a process flow diagram 400 for defining and offering for sale of a revenue-based investment security according to an embodiment of the disclosed subject matter.

The process flow diagram 400 starts at block 402 wherein the computer system receives inputs from administrator(s) representing the Entity to assign assets, goods or service to be offered as described herein. Inputs include a target amount of capital to be raised, information regarding the cost of goods, the good or service's current and potential valuation, etc.

The computer system determines a structure for the revenue-based investment security in block 404. The determination of the structure comprises conducting activities in blocks 221, 222 and 223 of FIG. 2B. It is to be appreciated that defining the structure of the offering in block 404 may comprise several iterative interactions between the computer system and administrator(s) or seller(s) to define the final structure of the security (arrow 405). It can be appreciated that some activities related to determining a structure for a revenue-based investment security may be considered confidential, so these activities may be conducted in portions of the computer system that are not distributed or accessible to parties (for example, potential investors) that are not authorized to participate in defining the offering.

Once the final structure of the offering is determined, the computer system moves to executing the offering (block 251 of FIG. 2B) by moving to block 406. Block 406 comprises offering the security for sale to potential investors. In the distributed networked computer system described herein, block 406 may comprise recording an entry in a distributed ledger that defines the offering. In embodiments using a blockchain as a distributed ledger, this entails inserting a block defining the offering in a blockchain. Block 408 comprises receiving bids for shares from investors. Receiving bids may comprise recording the bid information in the distributed ledger, such as by adding a block in the blockchain. As discussed above, in some embodiments, a buyer may bid on shares of goods or services already offered for sale by the seller or may enquire about assets not currently offered for sale. In embodiments wherein an investor initiates an enquiry about revenue stream(s), the inquiry is directed by the system from the investor into block 402 of the process flow scheme (arrow 409) for analysis and response from the seller(s). It is to be appreciated that defining the structure of buyer-initiated RBIS in block 404 may comprise several iterative interactions among the computer system, investors and administrator(s) or seller(s) (arrows 405 and 409) to define the final structure of the RBIS. Buyer-initiated enquiries and responses from sellers are recorded in the distributed ledger or blockchain as discussed above.

In certain embodiments, the issuance of the security takes place when there is not yet party to the agreement, in which case ownership of the revenue right is vested in a subscription. Should the project fail to attract investors to completely fund the project, the right will return to the initial owner (the Entity). In some embodiments the security product is not pooled together with other similar security products, but the good or service is offered on a particular basis, so the investment is in a specific item that is clearly identifiable.

Block 410 comprises accepting the bids from investors. Accepting the bids includes receiving payments from the investors and issuing shares to the investors at their bid price(s) and holding them in the computer system in the distributed ledger or blockchain. Accepting the bids may also include the system designing investor-initiated queries and submitting them for acceptance by the seller. As described above, acceptance of the bids by sellers may comprise generation of a smart contract that defines the final terms and conditions of the security, including payouts and triggering events.

It can be appreciated that once a first investor purchases a revenue-based investment security, the first inventor may choose to attempt to sell the RBIS he holds to a second investor. In that instance, the first investor may interact with the computer system as a seller and offer his share(s) for sale at block 406. A second investor can purchase such share(s) using steps 408 and 1410. Thus, the process 400 enables a distributed networked computer system described herein to serve as a marketplace for issuing, trading and administering RBIS.

The system tracks the sales of securities in block 412, including the total number of securities sold, the prices offered in bids and accepted by the computer system and the holders of the securities using a distributed ledger such as a blockchain. The computer system also tracks revenues associated with the goods or services sold and determines whether targets defined in the security have been met in block 414. In embodiments, a payout triggering event may comprise a first threshold that occurs when monetization of the goods exceeds expenses associated with producing the goods. Other triggering events may occur when monetization exceeds a specified percentage over the expenses, or when revenues exceed a specified amount. Notably, each triggering event can determine a different payout regime.

If the computer system determines that the target(s) are reached in block 414, the computer system moves to block 418 and disperses payments to investors based on the terms of the securities defined in the smart contract.

The system and methods described herein may be used for private offerings, initial public offerings or combinations thereof. For example, revenue-based investment securities may be offered to a limited number of private venture capital entities. It is to be appreciated that the terms and conditions of the revenue-based investment security are defined in a smart contract, so different smart contracts can be negotiated by different investors. For example, in a private offering each private venture capital entity may be able to negotiate terms and conditions separately from other private venture capital entities. In other examples, investors such as preferred investors, angel investors, accredited investors or venture capital investors willing and able to invest larger sums may obtain better terms than smaller investors. For example, such investors may be able to negotiate with the seller to define terms and conditions for a smart contract, while smaller investors may be limited to purchasing a security where the terms and conditions for a payout are non-negotiable. Larger investors may receive payouts starting at a first threshold that occurs when monetization of the good or service exceeds expenses associated with good or service, while smaller investors may not receive payouts after the first threshold and must wait for a payout at a different, higher threshold. In other words, only some of the smart contracts are executed to distribute a payout when the first threshold triggering event is met.

A RBIS is an example of an embodiment of a pass-through system for securitization of rights to a portion of a revenue stream associated with sale of goods or services by an entity. These rights are consolidated in the structuring of the rights securitization to create a pass-through RBIS negotiable on a stock exchange such as the NASDAQ. Investors become the holders of the pass-through security.

In certain embodiments the pass-through system is configured for direct ownership by multiple investors. Use of the pass-through system may establish a marketplace for revenue-based securities and provide for brokerage on the public or private market and thus facilitate the raising of capital for an entity to fund a business.

Therefore, the system and method provided herein may facilitate future revenue streams to be converted into a form of greater liquidity that enables faster, more transparent investment.

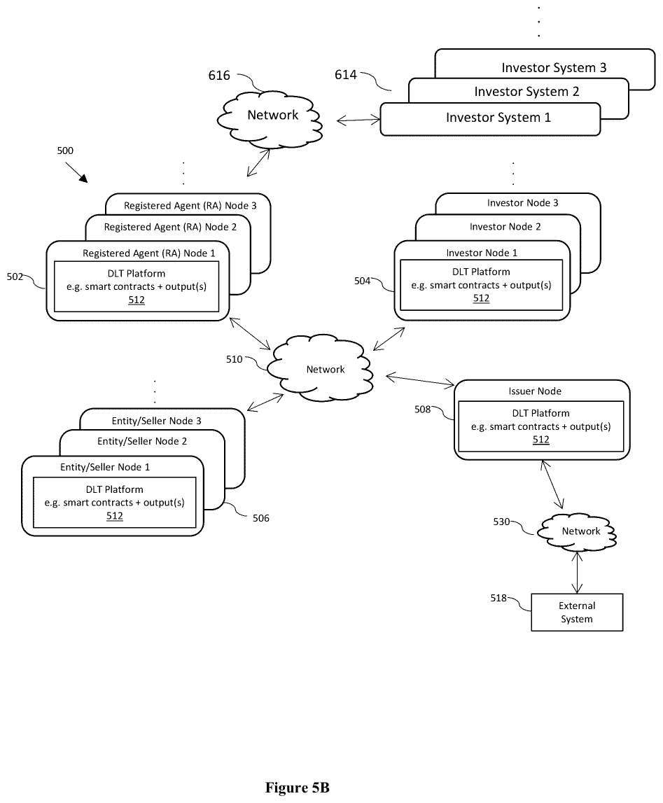

FIGS. 5A and 5B are schematic diagrams illustrating example embodiments of a system comprising nodes and users that may be involved in a smart system for securitizing revenue streams utilizing one or more smart contracts on a distributed ledger technology platform. A node is a connection point in a communications network and allow users to interact with the network. Each node is an endpoint for data transmissions or redistribution. Nodes have either a programmed or engineered capability to recognize, process and forward transmissions to other network nodes As illustrated in FIG. 5A, in some embodiments, a smart revenue-based investment security (RBIS) platform 500 can comprise one or more registered agent (RA) or dealer nodes 502, one or more investor nodes 504, one or more Entity (seller) nodes 506, and/or a central authority node 508, which can be in communication with one another through a network 510. The central authority node 508 is held by the issuer of the RBIS, such as a Revenue-Based Security Company (RBSC). In some embodiments, one or more of the RA node(s) 502, investor node(s) 504, Entity node(s) 506, and central authority node 508, such as node controlled by the issuer IPSC, can comprise a DLT platform 512 on which the smart RBIS platform, one or more smart contracts and smart contract outputs thereof, and/or one or more private data sharing channels may be implemented. In some embodiments, the DLT platform 512 can be configured to facilitate the filing, tracking, management, communications, notifications, or the like of the smart platform as described herein.

In some embodiments, the system 500 may also include systems external to the DLT as described below regarding FIG. 5B.

As illustrated in FIG. 5B, in some embodiments of a smart revenue-based investment security (RBIS) platform 505, one or more investor systems 514 may not comprise a DLT platform node. Rather, the one or more investor systems 514 can be configured to communicate with one or more RA nodes 502 comprising the DLT platform 512 through a separate network 516, for example through an application programming interface (“API”). As such, in some embodiments, one or more investor systems 514 may not be on the DLT itself. For example, small investors may be able to purchase securities from a registered agent or dealer in the distributed network, who is authorized to negotiate terms and conditions of the smart contracts on behalf of small investors. The RA may negotiate the terms and conditions prior to or after engaging with investors not on the DLT itself. Further, in some embodiments, central authority node 508 can be configured to maintain a separate external system 518. In some embodiments, the separate external system 518 can be in communication with the central authority node 508 through a separate network connection 530, such as an API, for example for purposes of maintaining legally valid versions of the RBIS filings. In some embodiments, the smart filings on the DLT itself can be the legally valid and canonical version of the filings. In embodiments, the external system may also include modules for managing the securitization that are desirably kept separate from the distributed ledger. For example, owner confidential information and pre-issuance activities such as valuation of and administering securities (e.g. blocks 220 and 250 of FIGS. 2A and 2B and blocks 402 and 404 of FIG. 4) may be held in the separate external system. In other embodiments, the smart revenue-based investment security (RBIS) platform may comprise a combination of investors 504 with nodes on the distributed ledger and investors 514 without nodes on the distributed ledger.

In various embodiments the specific system of securitization enables trades to take place on the NASDAQ or other exchange. Therefore, a holder may exit at the stage of brokerage through a public or private offering. The system and method presented herein provide a vehicle for individuals to invest and for an individual issuer or a collective issuer to raise capital originating from multiple investors.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A security for monetizing or securitizing revenue, wherein the security comprises a pass-through security that pays a portion of a revenue stream, such as a payment based on sales of goods or services, to the holder of the security as the revenue is received by the issuer of the security.

2. A revenue-based investment security (RBIS) comprising investment shares backed by a revenue stream based on an assigned good, service or asset providing a defined payout to an investor based on a portion of the revenue stream.

3. A distributed networked computer system for managing securitization of revenue streams, the distributed network computer system comprising:
a non-transitory computer readable storage medium having program instructions embodied therewith; and
one or more processors configured to execute the program instructions to cause the computing system to:
receive, from a first networked node, a first bid for one or more shares of a revenue-based investment security (“RBIS”) from a first investor;
determine, by a central processor, a fractional share of the RBIS to allocate to the first investor based on the first bid;
allocate, by one or more processors, the fractional share of the RBIS to the first investor;
a distributed ledger for recording bids for the RBIS and respective allocated shares determined by the central processor, wherein the distributed ledger is accessible by the first networked node; and
a smart contract accessible to the first networked node, wherein the smart contract comprises:
a revenue stream payout triggering event; and
a plurality of predetermined electronic actions for generating a smart contract output when the revenue stream payout triggering event is met, wherein the smart contract generates a revenue stream payout to the first investor automatically when the payout event is triggered, and further wherein the execution of the smart contract is recorded to the distributed ledger.

4. The distributed network of claim 3, wherein the smart contract is between the first investor and an issuer of the revenue-based investment security.

5. The distributed network of claim 3, wherein the payout triggering event is based on revenue associated with sale of a good or service.

6. The distributed network of claim 3, further comprising one or more processors configured to execute the program instructions to cause the computing system to:
receive, from a plurality of networked nodes, a plurality of bids for one or more shares of a revenue-based investment security (“RBIS”) from a plurality of investors,
determine, by the central processor, a fractional share of the RBIS to allocate to each of the plurality of investors based on the respective bids associated with each investor; and
allocate, by one or more processors, the fractional shares of the RBIS to each of the plurality of investors.

7. The distributed network of claim 6, wherein a plurality of smart contracts are accessible to the plurality of networked nodes, wherein each of the plurality of smart contracts comprises:
a revenue stream payout triggering event; and
a plurality of predetermined electronic actions for generating a smart contract output when the revenue stream payout triggering event is met, wherein the smart contract generates a revenue stream payout to at least some of the plurality of investors automatically when the revenue stream payout event is triggered, and further wherein each execution of each of the smart contracts is recorded to the distributed ledger.

8. The distributed network of claim 7, wherein the payout is a portion of a revenue associated with sale of a good or service.

9. The distributed network of claim 7, wherein the payout triggering event comprises a first threshold that occurs when monetization of the good exceeds total expenses associated with producing the good.

10. The distributed network of claim 9, wherein only some of the smart contracts are executed to distribute a payout when the first threshold is met.

11. A non-transitory computer readable storage medium comprising a plurality of computer readable instructions embodied thereon wherein the instructions, when executed by a distributed networked computer system for managing securitization of revenue, cause the distributed networked computer system to:
receive, from a first networked node, a first bid for one or more shares of a revenue-based investment security (“RBIS”) from a first investor;
determine, by a central processor, a fractional share of the RBIS to allocate to the first investor based on the first bid;
allocate, by one or more processors, the fractional share of the RBIS to the first investor;
record in a distributed ledger, wherein the distributed ledger is accessible by the first networked node,
bids for the RBIS;
respective allocated shares determined by the central processor; and
execution of a smart contract accessible to the first networked node, wherein the smart contract comprises:
a revenue stream payout triggering event; and
a plurality of predetermined electronic actions for generating a smart contract output when the revenue stream payout triggering event is met, wherein the smart contract generates a revenue stream payout to the first investor automatically when the payout event is triggered.

12. The non-transitory computer readable storage medium of claim 11, wherein the smart contract is between the first investor and an issuer of the revenue-based investment security.

13. The non-transitory computer readable storage medium of claim 11, wherein the payout triggering event is based on revenue associated with monetization of the revenue stream.

14. The non-transitory computer readable storage medium of claim 11, wherein the instructions further cause the distributed networked computer system to:
receive, from a plurality of networked nodes, a plurality of bids for one or more shares of a revenue-based investment security (“RBIS”) from a plurality of investors,
determine, by the central processor, a fractional share of the RBIS to allocate to each of the plurality of investors based on the respective bids associated with each investor; and allocate, by one or more processors, the fractional shares of the RBIS to each of the plurality of investors.

15. The non-transitory computer readable storage medium of claim 14, wherein the instructions further cause the distributed networked computer system to
record to the distributed ledger a plurality of smart contracts accessible to the plurality of networked nodes, wherein each of the plurality of smart contracts comprises:
a revenue stream payout triggering event; and
a plurality of predetermined electronic actions for generating a smart contract output when the revenue stream payout triggering event is met, wherein the smart contract generates a revenue stream payout to at least some of the plurality of investors automatically when the revenue stream payout event is triggered and further wherein each execution of each of the smart contracts is recorded to the distributed ledger.

16. The non-transitory computer readable storage medium of claim 11, wherein the payout is a portion of a revenue associated with sale of a good or service.

17. The non-transitory computer readable storage medium of claim 15, wherein the payout triggering event comprises a first threshold that occurs when monetization of the good exceeds total expenses associated with producing the good.

18. The non-transitory computer readable storage medium of claim 17, wherein only some of the smart contracts are executed to distribute a payout when the first threshold triggering event is met.

19. A method for managing securitization of revenue by a distributed networked computer system, the method comprising:
receiving, from a first networked node, a first bid for one or more shares of a revenue-based investment security (“RBIS”) from a first investor;
determining, by a central processor, a fractional share of the RBIS to allocate to the first investor based on the first bid;
allocating, by one or more processors, the fractional share of the RBIS to the first user;
recording in a distributed ledger, wherein the distributed ledger is accessible by the first networked node, bids for the RBIS;
respective allocated shares determined by the central processor; and
execution of a smart contract accessible to the first networked node, wherein the smart contract comprises:
a revenue stream payout triggering event; and
a plurality of predetermined electronic actions for generating a smart contract output when the revenue stream payout triggering event is met, wherein the smart contract generates a revenue stream payout to the first investor automatically when the payout event is triggered.

20. The method of claim 19, wherein the smart contract is between the first investor and an issuer of the revenue-based investment security.

21. The method of claim 19, wherein the payout triggering event is based on revenue associated with monetization of a good or service.

22. The method of claim 19, further comprising:
receiving, from a plurality of networked nodes, a plurality of bids for one or more shares of a revenue-based investment security (“RBIS”) from a plurality of investors,
determining, by the central processor, a fractional share of the RBIS to allocate to each of the plurality of investors based on the respective bids associated with each investor; and
allocating, by one or more processors, the fractional shares of the RBIS to each of the plurality of investors.

23. The method of claim 22, further comprising:
recording to the distributed ledger a plurality of smart contracts accessible to the plurality of networked nodes, wherein each of the plurality of smart contracts comprises:
a revenue stream payout triggering event; and
a plurality of predetermined electronic actions for generating a smart contract output when the revenue stream payout triggering event is met, wherein the smart contract generates a revenue stream payout to at least some of the plurality of investors automatically when the revenue stream payout event is triggered and further wherein each execution of each of the smart contracts is recorded to the distributed ledger.

24. The method of claim 23, wherein the payout triggering event comprises a first threshold that occurs when the monetization of a good exceeds total expenses associated with producing the good.

25. The method of claim 24, wherein only some of the smart contracts are executed to distribute a payout when the first threshold is met.
